(19) United States
(12) Patent Application Publication
(10) Pub. No.: US 2014/0226018 A1
(43) Pub. Date: Aug. 14, 2014

(54) Access Control System

(71) Applicant: SICK AG, Waldkirch (DE)

(72) Inventors: Markus Wagner, Waldkirch (DE); Matthias Mezger, Waldkirch (DE)

(73) Assignee: SICK AG, Waldkirch (DE)

(21) Appl. No.: 14/157,186

(22) Filed: Jan. 16, 2014

(30) Foreign Application Priority Data
Feb. 8, 2013 (DE) 20 2013 100 591.6

(51) Int. Cl. G06K 7/10

(52) U.S. Cl. CPC G06K 7/10366
USPC 348/156; 340/5.65

(57) ABSTRACT

The present invention relates to an access control system for the control of the access of an object to a portal, the system comprising an optoelectronic sensor for the detection of a movement direction of the object, an RFID reading device and an evaluation unit for the evaluation of the signals of the optoelectronic sensor and of the RFID reading device, wherein only permitted objects may pass through the portal. The invention is characterized in that the optoelectronic sensor is configured to detect a pre-field of the portal in a horizontal two-dimensional plane and in that the evaluation unit is an integral component of the sensor and of the RFID reading device.

The invention relates to an access control system for the control of the access of an object to a portal, comprising an optoelectronic sensor for the detection of a movement direction of the object, an RFID reading device and an evaluation unit for the evaluation of the signals of the optoelectronic sensor and of the RFID reading device, wherein only permitted objects may pass through the portal.

Such a system is known from the U.S. Pat. No. 7,100,052 B2. There the access to a portal is secured by means of a plurality of light barriers and an RFID reading device. It can be determined whether an object moves towards the portal or away from this by means of the light barriers arranged one after the other in the direction towards the portal. When the object moves towards the portal an RFID tag, which the object has to carry, is read and when it is determined that it is a permitted object the access is allowed and the portal is open. The light barriers and the RFID reading device are connected to a CPU calculation unit which evaluates all of the signals of the light barriers and of the RFID reading device.

It is a disadvantage of such a system that only the simplest form of information “an object is moving in the direction towards the portal” can be determined with light barriers arranged in such a manner. A manipulation of the system, for example, in that a non-permitted person moves directly and without a spacing behind a permitted object, for example, a forklift truck, can not be detected in this way. For this reason, the known system is unsecure. It is further disadvantageous that an additional calculation unit is required for the processing of the signals of the at least two light barriers and of the RFID reading device which is demanding in effort and is cost-ineffective.

Starting from this state of the art it is the object of the invention to make available an improved access control system which avoids these disadvantages.

This object is satisfied by an access control system having the features of claim 1.

The access control system in accordance with the invention serves for the control of the access of an object to a portal. It has at least one optoelectronic sensor for the detection of a movement direction of the object, an RFID reading device and an evaluation unit for the evaluation of the signals of the optoelectronic sensor and of the RFID reading device, wherein only permitted objects may pass through the portal. Furthermore, in accordance with the invention the optoelectronic sensor is configured in such a way that a pre-field of the portal is detected in a horizontal two-dimensional plane by the sensor and in that the evaluation unit is an integral component of the sensor and of the RFID reading device.

A self-sufficient access control system is created by means of the invention through the intelligent networking of 2-D measurement technology and RFID without the additional use of an external personal computer (PC) or a superordinate control. Furthermore a subsequent monitoring is also possible by means of the sensor through the two-dimensional detection, i.e. the subsequent monitoring is the monitoring of whether a non-permitted object follows a permitted object. Furthermore, also a blockage of the pre-field by means of permanently put-down objects can be recognized.

In this connection the flow of goods remains in movement and neither processes nor persons have to be stopped in order to identify themselves for the access. The system is detected and evaluates fast and in a secure manner and in this respect is insensitive to extraneous light and is robust.

It is flexible and can easily be matched to customer requirements simply without the use of an additional external PC or software. The system can easily be retrofitted and can be matched to all common alarm systems and breaking and entering detection systems for small costs of installation and for a fast integration of commercially available sensor components. It satisfies the purposes and requirements of, for example, the Customs Trade Partnership Against Terrorism (C-TPAT) and the European certificate “Authorised Economic Operator (AEO).

Advantageously, a classification of the object takes place by means of the sensor, e.g. into categories, such as, forklift truck, different vehicles, person.

In a simple manner this information on the permissibility of the object is stored in an RFID tag which is carried by the object. In that case the system needs no prior knowledge.

When the optoelectronic sensor is configured as a laser scanner which scans the plane one can use commercially available laser scanners which have already been VdS certified and in this way work reliably in a confirmed manner. Such a laser scanner is, for example, known under the designation LMS123 from the applicant.

It is advantageous when the laser scanner divides the pre-field into individual fields for a simplified evaluation of the laser scanner data.

In order to in particular avoid a shading of the wide pre-fields and in this way to prevent non-permitted objects from remaining undetected in the shade of a permitted object it is provided in an embodiment of the invention that two laser scanners are provided which are positioned on both sides of the pre-field and which can scan the pre-field in horizontal planes.

It is also plausible that the optoelectronic sensor is configured as a 3-D camera which is positioned above the pre-field and is directed from above onto the pre-field. In this manner, e.g. the disadvantages of the shading can be avoided without a second sensor. The 3D camera would carry out a recording of the scenery from above and would carry out both a recognition of the direction and also a classification by means of an intelligent evaluation without having to consider substantial shading problems. However, to date a 3-D camera is still very demanding in cost and is non-certified.

In the following, the invention will be explained in detail with reference to the drawing by means of an embodiment.

The only FIGURE of the drawing shows an access control system 10 in accordance with the invention which serves for the control of the access of an object 12 or 22 to a portal 14. The portal 14 can, for example, be a roller door 16 which separates a region of danger 18 from a danger-free access region 20. In the region of danger 18 only authorized, this means permitted objects, such as a conveyor vehicle 12 or an authorized person 22 can enter. It is the object of the access control system 10 to only permit access to the region of danger 18 to these permitted objects 12 and 22 and to recognize non-permitted objects, such as the persons or otherwise non-permitted objects indicated at the reference numerals 24 and 26 and to ensure that these non-permitted objects 24, 26 cannot arrive in the region of danger 18.

The permitted objects differ from the non-permitted objects in that they carry an RFID tag 40 in which information is stored which states that these objects are permitted.

The access control system 10 is arranged in the access region 20 which is bounded at the sides by lateral walls 28 and 30 and comprises an RFID reading device 32 and at least one optoelectronic sensor 34 which scans a pre-field 36 in at least one horizontal plane in front of the portal 14. The RFID reading device 32 and the optoelectronic sensor 34, which is preferably configured as a laser scanner, are connected to one another via a line 38 in such a way that they mutually exchange information for which purpose an evaluation unit is integrated in both.

The functional principle of the access control system 10 will be described in the following. When a permitted object—in the illustrated embodiment this is a conveyor vehicle 12—which is pulled by a person 22 enters into the pre-field 36 this is recognized by the laser scanner 34. The region of sight of the laser scanner scans the pre-field 36 which is divided into a portal distant pre-field 36-1 and a portal near pre-field 36-2. When the object enters into the portal distant pre-field 36-1 it is recognized by the laser scanner 34 and a signal is output to the RFID reading device 32 which is activated thereupon. The RFID reading device 32 will read the RFID tag 40 in which it is coded that the carrier of this RFID tag 40 has an access permission. This information is then given back to the laser scanner 34 so that this outputs the signal “green”. This means that finally the portal 14 and in this way the access to the region of danger 18 can be opened.

However, this only takes place when it is always ensured that no non-permitted object is present in the pre-field, be it in the portal near pre-field or the portal distant pre-field.

However, when the laser scanner 34 detects a non-permitted object, be it with or without a permitted object 12, 22 in the pre-field 36 then the laser scanner 34 outputs a warning or safety signal in such a way that the portal 14 remains closed and the access to the region of danger 18 is refused. Such a non-permitted object can, for example, be a person shown at the reference numeral 24 who is sneaking behind the conveyor vehicle 12 (so-called “tailgaiting”) and the person does not carry an RFID tag 40 which would state a permittability.

When the permitted objects, for example the forklift truck 12, are considerably narrower than the spacing between the sidewalls 28 and 30, an unpermitted object 26 could be present in the shadow of the vehicle 12 and in this way be present outside of the region of recognition of the laser scanner 34 and would not be recognized. In order to avoid this shading problem a second laser scanner 42 is arranged at the wall 30 on the side lying opposite of the laser scanner 34 which second laser scanner can precisely detect the shaded regions. This laser scanner 42 will then recognize the non-permitted object 26 and forward this information to the RFID reading device 32 via a line 44, which RFID reading device can then not associate any RFID information with this object 36 so that this is identified as non-permitted. Thereupon, the warning signal or safety signal is output again either by the laser scanner 32 or by the laser scanner 42. So that the two opposing laser scanners 34 and 42 do not blind one another it is sensible to arrange these at slightly different heights such that their scanning planes are displaced in parallel with regard to their height.

In an embodiment of the invention the laser scanner 34 and/or 42 can carry out a classification of the objects 12, 22, 44, 26. In this way, for example, a differentiation between vehicles and persons could take place which can possibly be helpful on the differentiation of whether it is a permitted object or a non-permitted object and can simplify the evaluation.

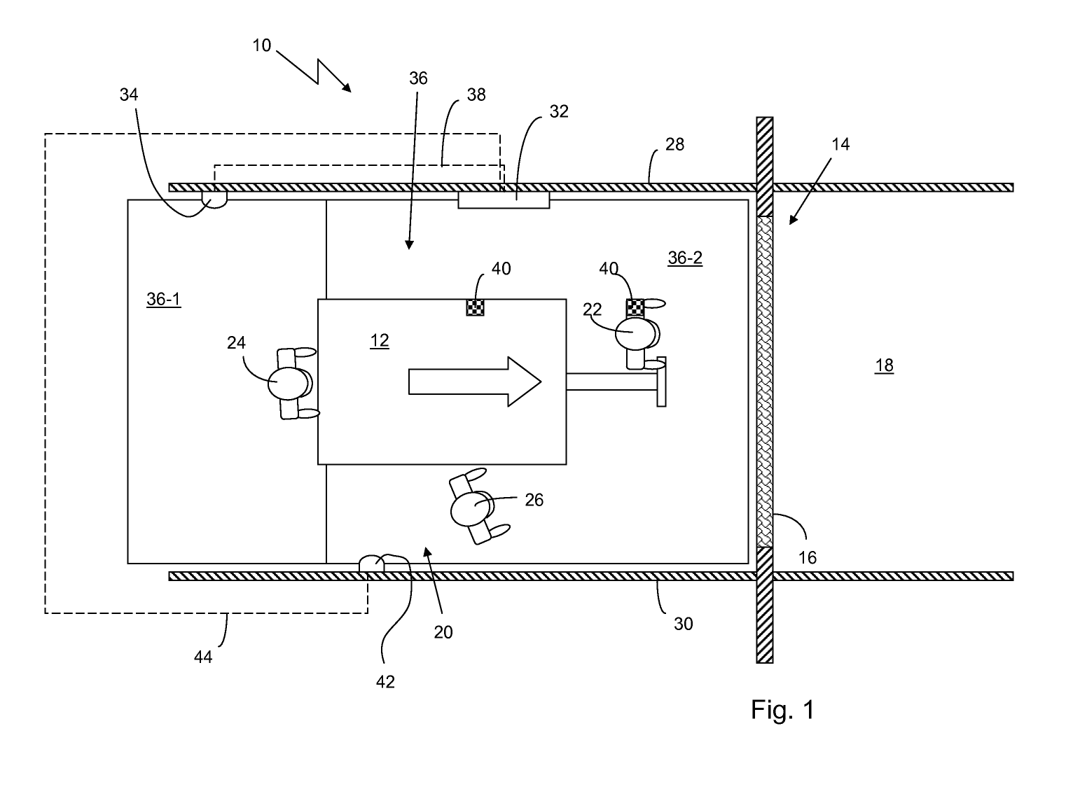

In a further non-illustrated embodiment the laser scanners 34 and 42 could be replaced by a 3-D camera which can look onto the scenery in the pre-field 36 from above and would have the perspective as is illustrated in FIG. 1. The problems of shading would be avoided by means of such a camera.

What is claimed is:

1. An access control system for the control of the access of an object to a portal, comprising an optoelectronic sensor for the detection of a movement direction of the object, an RFID reading device and an evaluation unit for the evaluation of the signals of the optoelectronic sensor and of the RFID reading device, wherein only permitted objects may pass through the portal, wherein the optoelectronic sensor is configured to detect a pre-field of the portal in a horizontal two dimensional plane and wherein the evaluation unit is an integral component of the sensor and of the RFID reading device.

2. The access control system in accordance with claim 1, wherein a classification of the object takes place by means of the sensor.

3. The access control system in accordance with claim 1, wherein the information on the permissibility of the object is stored in an RFID tag which is carried by the object.

4. The access control system in accordance with claim 1, wherein the optoelectronic sensor is configured as a laser scanner which scans the plane.

5. The access control system in accordance with claim 1, wherein the laser scanner divides the pre-field into individual fields.

6. The access control system in accordance with claim 1, wherein two laser scanners are provided which are positioned on both sides of the pre-field and which scan the pre-field in horizontal planes.

7. The access control system in accordance with claim 1, wherein the optoelectronic sensor is configured as a 3D camera which is positioned above the pre-field and is directed from above onto the pre-field.
